(19) United States
(12) Patent Application Publication
(10) Pub. No.: US 2026/0060183 A1
(43) Pub. Date: Mar. 5, 2026

(54) HIGH BRANCH SCISSORS

(71) Applicant: Yongkang Gold Arrow Metal Products Co.,Ltd., Jinhua (CN)

(72) Inventor: Zihao SHI, Jinhua (CN)

(21) Appl. No.: 18/964,736

(22) Filed: Dec. 2, 2024

(30) Foreign Application Priority Data
Sep. 5, 2024 (CN) 2024221714091

(51) Int. Cl. A01G 3/025; B25G 1/04

(52) U.S. Cl. CPC A01G 3/0255; B25G 1/04

(57) ABSTRACT

High branch scissors comprising a first long rod shell, wherein a first fixing sleeve is arranged at a tail portion of the first long rod shell, a handle is slidably arranged on the first long rod shell, a telescopic assembly is arranged in the first long rod shell, and a scissors assembly is arranged at the top of the telescopic assembly. The interaction between the moving pulleys and the first steel rope reduces the operating resistance when pruning. The operation of scissors assembly is capable of being controlled by means of the handle. The first gear and the gear scissors blade are engaged and the second scissors blade is movably connected to the gear scissors blade through a bolt, thereby achieving the shearing function of the scissors assembly. Through adopting the present invention, a large force is transmitted during pruning, and the efficiency is improved.

### TECHNICAL FIELD

This invention generally relates to the technical field of garden pruning tools, and more particularly, to high branch scissors.

### BACKGROUND

In garden pruning, garden scissors are one of commonly used tools for pruning tree branches, flower branches and hedges, thereby ensuring the healthy growth of plants while making them aesthetically appealing. High branch scissors are tools specially designed for pruning high branches.

The tail portion of the blades of the conventional high branch scissors is normally provided with a nylon rope for allowing a user to yanking on the rope to achieve branch pruning. However, to successfully prune thicker branches, it may need a large force and repeated attempts, resulting in laborious process and low efficiency. Using conventional high branch scissors for pruning high branches in a prolonged period requires a user's high physical strength and endurance, and continuous output of a great force easily causes discomfort such as muscle fatigue and soreness.

### SUMMARY

The purpose of the present invention is to provide high branch scissors.

To achieve the above purpose, the present invention adopts the following technical solution: high branch scissors comprising a first long rod shell, wherein a first fixing sleeve is arranged at a tail portion of the first long rod shell, a handle is slidably arranged on the first long rod shell, a telescopic assembly is arranged in the first long rod shell, and a scissors assembly is arranged at the top of the telescopic assembly.

In another preferred embodiment, the telescopic assembly comprises a second fixing sleeve arranged in the first long rod shell, a second long rod shell is arranged at the top of the second fixing sleeve, and the second long rod shell is connected to the first long rod shell through a third fixing sleeve. A fixing rod is arranged inside the second fixing sleeve, and a first mounting block is arranged at the top of the fixing rod. A second moving pulley is movably arranged in the first mounting block, and a first moving block is movably arranged inside the second long rod shell. A first moving pulley and a third moving pulley are movably arranged in the first moving block. A first connecting member is arranged at the top of the first moving block.

In another preferred embodiment, a first fixing block, a second fixing block and a third fixing block are arranged on one side of the handle.

In another preferred embodiment, the first steel rope is arranged in the second long rod shell, and the head portion of the first steel rope is arranged on the second fixing block. The first steel rope penetrates through the third fixing sleeve along the first long rod shell and then penetrates through a square hole in the second long rod shell on one side of the third fixing sleeve. The first steel rope is sequentially wound around the first moving pulley, the second moving pulley, the third moving pulley and a first clamping groove in the second fixing sleeve. The tail portion of the first steel rope is arranged inside the third fixing sleeve.

In another preferred embodiment, a second steel rope is arranged on an outer wall of the first long rod shell, and the head portion of the second steel rope is arranged on the third fixing block. The tail portion of the second steel rope is arranged at the bottom of the first fixing sleeve.

In another preferred embodiment, the scissors assembly comprises a second mounting shell arranged at the top of the second long rod shell, and a first mounting shell is arranged on one side of the second mounting shell. The second mounting shell is connected to the first mounting shell by means of a plurality of groups of bolts. A first rotating shaft is arranged between the first mounting shell and the second mounting shell, and a first hexagonal shaft sleeve and a second hexagonal shaft sleeve are arranged on the first rotating shaft. A first rotating disc is arranged on the first hexagonal shaft sleeve, and the first rotating disc is located inside the first mounting shell. A second rotating disc is arranged on the second hexagonal shaft sleeve, and a coil spring is arranged in the second rotating disc. The second rotating disc is located in the second mounting shell, and a second rotating shaft is arranged in the second mounting shell. A rolling wheel is movably arranged on the second rotating shaft, and a third steel rope is wound on the first rotating disc. The third steel rope is sequentially wound around the rolling wheel, the first connecting member and the second rotating disc, and the tail portion of the third steel rope is connected to the coil spring.

In another preferred embodiment, the first rotating shaft is provided with a first gear, and the first gear abuts between the first hexagonal shaft sleeve and the second hexagonal shaft sleeve. The first gear is engaged with a gear scissors blade. One side of the top of the second mounting shell is provided with a second scissors blade, and the gear scissors blade is movably connected to the second scissors blade.

In another preferred embodiment, the scissors assembly comprises a first fixing cylinder arranged on the second long rod shell, the top of the second long rod shell is provided with a mounting sleeve, and the top of the first moving block is provided with a second connecting member. A fourth fixing block and a fifth fixing block are arranged inside the second connecting member. A second moving block is arranged at a position corresponding to the mounting sleeve inside the second long rod shell, a fourth moving pulley is arranged at the bottom of the second moving block.

In another preferred embodiment, the top of the second moving block is provided with the pull rod. One side of the pull rod away from the second moving block is provided with a third scissors blade, and a fourth scissors blade is movably arranged on the third scissors blade through a bolt. The fourth scissors blade is arranged on one side of the mounting sleeve through a bolt, and the third scissors blade is connected to the mounting sleeve through a spring. The fourth steel rope is arranged on the fourth fixing block and is sequentially wound around the fifth fixing block and the fourth moving pulley. The tail portion of the fourth steel rope is fixed inside the first fixing cylinder.

Compared with the prior art, the present invention has the following advantages:
1. By arranging the telescopic assembly, the interaction between the moving pulleys and the first steel rope significantly reduces the operating resistance when pruning; by means of the connection of the first fixing sleeve, the second fixing sleeve and the third fixing sleeve, as well as the steel ropes stably wound in the pulleys and the clamping grooves, the reliability and stability of the telescopic assembly during operation is ensured; the handle allows a user to control the scissors assembly, achieving simple process and easy operation;
2. By arranging the scissors assembly, the first mounting shell and the second mounting shell are tightly connected through a plurality of groups of bolts; the first mounting shell and the second mounting shell provide stable support for components such as the first rotating shaft, the second rotating shaft and the rolling wheel in the scissors assembly, thereby ensuring the stability and reliability of the gear scissors blade and the second scissors blade during operation; the first connecting member is pulled by the telescopic assembly to pull the third steel rope, thereby making the first rotating shaft rotate such that the gear scissors blade and the second scissors blade are closed; the first gear and the gear scissors blade are engaged and the second scissors blade is movably connected to the gear scissors blade through a bolt, thereby achieving the pruning function of the scissors assembly; through adopting the present invention, a large force is transmitted during pruning, and the efficiency is improved; by providing the coil spring inside the second rotating disc of the scissors assembly, after the pruning is completed, the handle is released, and the coil spring automatically releases energy such that the scissors assembly is reset; thus, the operating efficiency is improved and the operating burden on the user is alleviated;
3. By arranging the scissors assembly, the fourth steel rope is wound around the fourth fixing block, the fifth fixing block and the fourth moving pulley, allowing the opening and closing of the third scissors blade to be controlled; when the user holds the handle and pulls along the first long rod shell, the telescopic assembly propels the second connecting member, thereby pulling the fourth steel rope to propel the fourth moving pulley to rotate; thus, the pull rod is further pulled, making the third scissors blade and the fourth scissors blade move relative to each other to realize pruning; the aforesaid design makes the opening and closing of the scissors more stable and smooth; because the third scissors blade is connected to the mounting sleeve by means of a spring, after the pruning is completed, the user releases the handle, and the spring automatically reset the third scissors blade to the initial position, so that the pruning efficiency is improved and the operating burden on the user is reduced;
4. By arranging the handle and the second steel rope, one end of the second steel rope is arranged on the handle, and the other end of the second steel rope is arranged at the tail portion of the first fixing sleeve; thus, when the scissors assembly is reset, the handle is limited, preventing the handle from excessively rising when the coil spring or the spring rebounds.

### BRIEF DESCRIPTION OF THE DRAWINGS

FIG. 1 is a schematic diagram illustrating an exemplary overall structure in embodiment 1 of the present invention;

FIG. 2 is a schematic diagram illustrating an overall internal structure in embodiment 1 of the present invention;

FIG. 3 is a schematic diagram illustrating an enlarged structure of portion E in FIG. 2;

FIG. 4 is a schematic diagram illustrating an enlarged structure of portion C in FIG. 2;

FIG. 5 is a schematic diagram illustrating an enlarged structure of portion B in FIG. 2;

FIG. 6 is a schematic diagram illustrating an enlarged structure of portion A in FIG. 2;

FIG. 7 is a schematic diagram illustrating an exemplary structure of the second fixing sleeve in the telescopic assembly in embodiment 1 of the present invention;

FIG. 8 is a schematic diagram illustrating an explosive view of the scissors assembly in embodiment 1 of the present invention;

FIG. 9 is a schematic diagram illustrating an exemplary structure of the gear scissors blade and the second scissors blade of the scissors assembly in embodiment 1 of the present invention;

FIG. 10 is a schematic diagram illustrating an exemplary overall structure in embodiment 2 of the present invention;

FIG. 11 is a schematic diagram illustrating an overall internal structure in embodiment 2 of the present invention;

FIG. 12 is a schematic diagram illustrating an enlarged structure of portion D in FIG. 11;

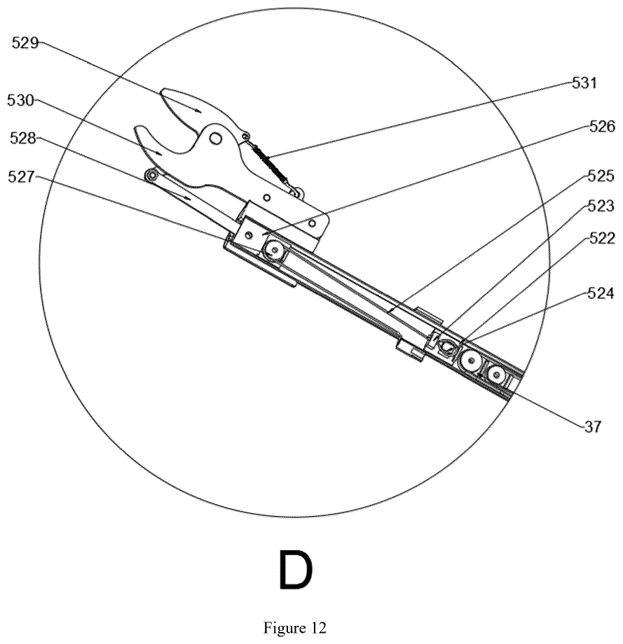

In Figures: 1—The First Long Rod Shell, 2—The First Fixing Sleeve, 3—Telescopic Assembly, 31—The Second Fixing Sleeve, 32—The Second Long Rod Shell, 33—Fixing Rod, 34—The First Steel Rope, 35—The Third Fixing Sleeve, 37—The First Moving Block, 38—The First Mounting Block, 39—The Second Moving Pulley, 310—The Third Moving Pulley, 311—The First Clamping Groove, 312—The First Connecting Member, 313—The First Moving Pulley, 4—Handel, 41—The First Fixing Block, 42—The Second Fixing Block, 43—The Third Fixing Block, 5—Scissors Assembly, 51—The First Mounting Shell, 52—The Second Mounting Shell, 53—The Third Steel Rope, 54—The First Rotating Disc, 56—The Second Rotating Disc, 57—The First Rotating Shaft, 58—The First Gear, 510—The Gear Scissors Blade, 511—The Second Scissors Blade, 513—Coil Spring, 515—The First Hexagonal Shaft Sleeve, 518—The Second Hexagonal Shaft Sleeve, 519—Rolling Wheel, 520—The First Fixing Cylinder, 521—Mounting Sleeve, 522—The Second Connecting Member, 523—The Fourth Fixing Block, 524—The Fifth Fixing Block, 525—The Fourth Steel Rope, 526—The Second Moving Block, 527—The Fourth Moving Pulley, 528—Pull Rod, 529—The Third Scissors Blade, 530—The Fourth Scissors Blade, 531—Spring, 6—The Second Steel Rope.

### DETAILED DESCRIPTION

To make the purpose, technical solution and advantages of the present invention clearer and more understandable, drawings and specific embodiments are combined hereinafter to further elaborate the present invention. It should be understood that following descriptions are merely illustrative and are not intended to limit the scope of the present invention. In addition, descriptions of known structures and technologies are omitted to avoid unnecessary confusion of the concept of the present invention.

### Embodiment 1

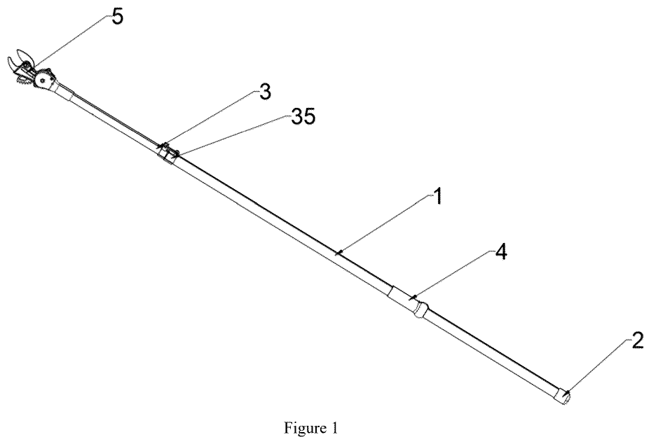

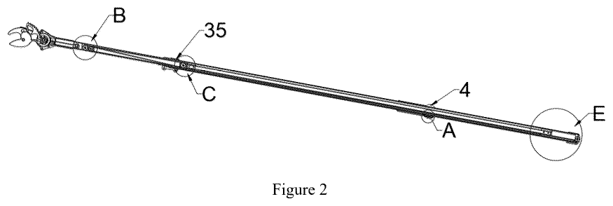

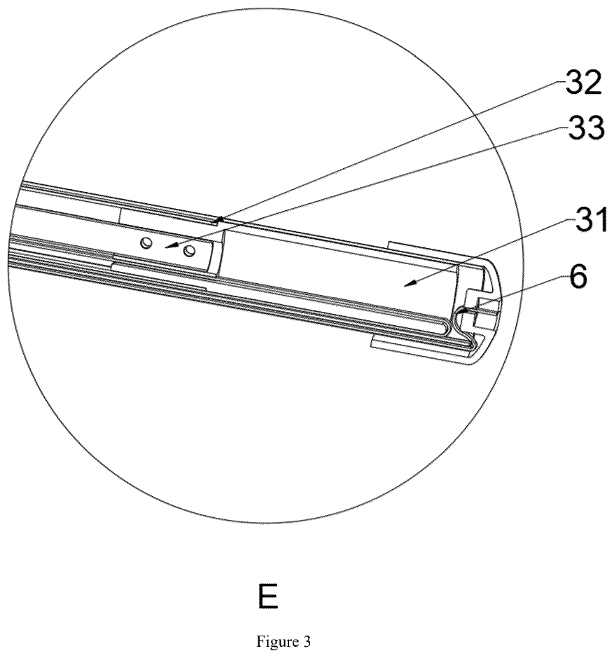

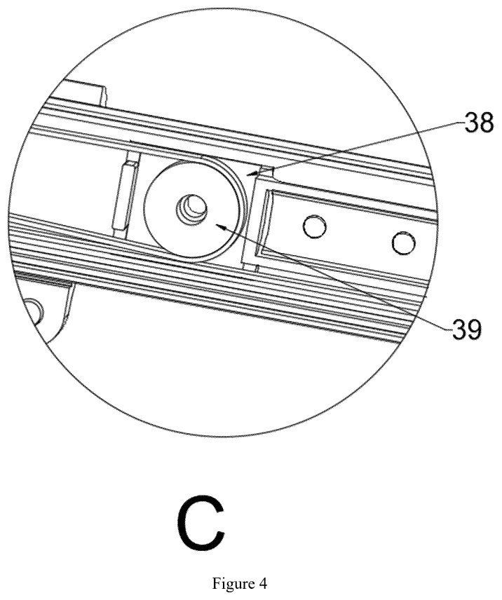

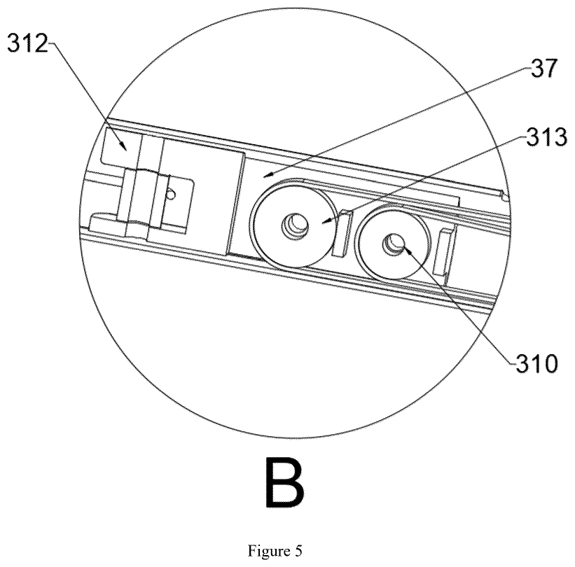

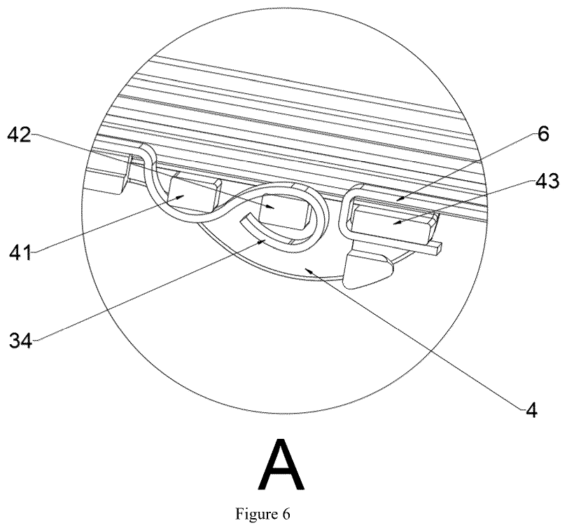

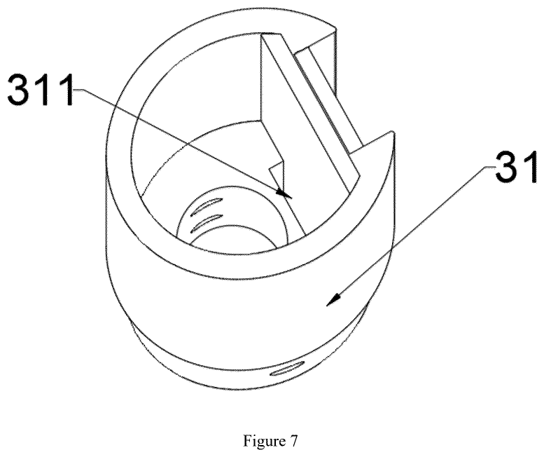

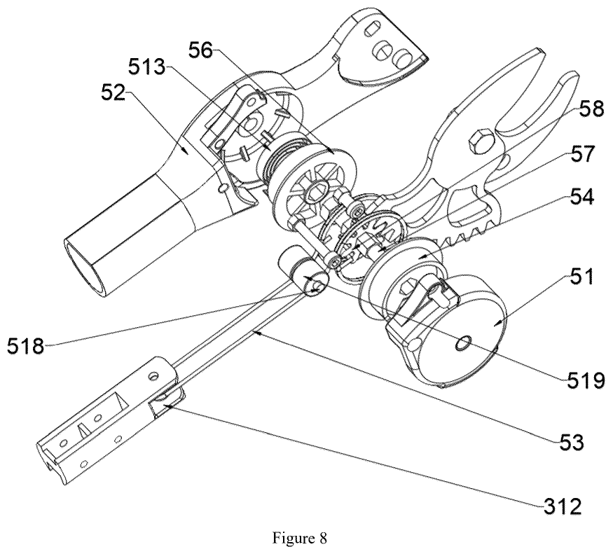

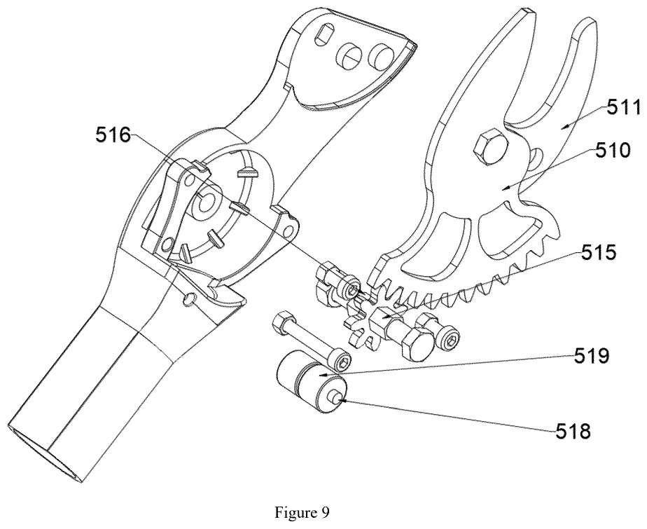

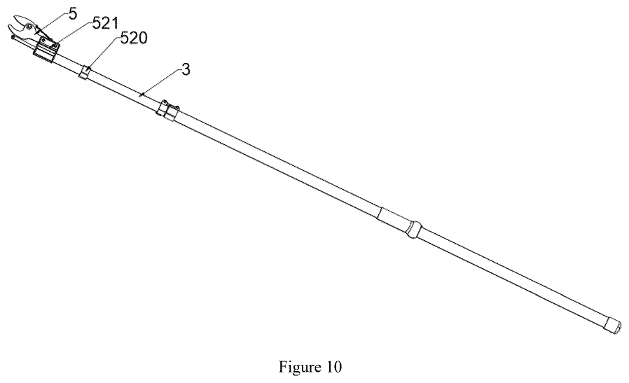

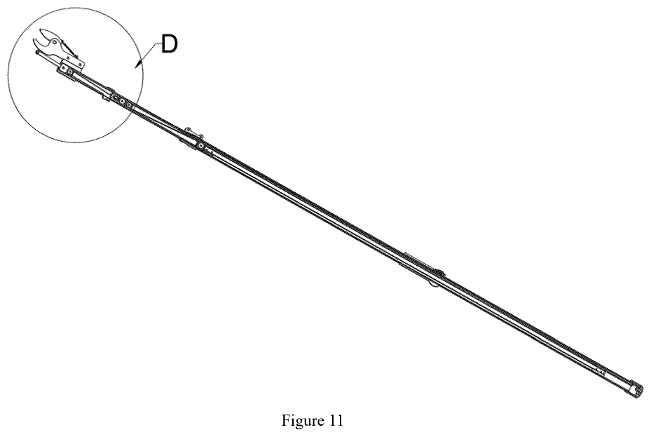

Referring to FIGS. 1-11, the present invention provides high branch scissors, comprising a first long rod shell 1, wherein the first long rod shell 1 provides sufficient strength and stability to support an internal telescopic assembly 3. A first fixing sleeve 2 is arranged at a tail portion of the first long rod shell 1, and the first fixing sleeve 2 is used for connecting the first long rod shell 1 and a second fixing sleeve 31. A handle 4 is slidably arranged on the first long rod shell 1, the telescopic assembly 3 is arranged in the first long rod shell 1, and a scissors assembly 5 is arranged at the top of the telescopic assembly 3.

The telescopic assembly 3 comprises the second fixing sleeve 31 arranged in the first long rod shell 1, and the second fixing sleeve 31 is used for supporting a second long rod shell 32 and a fixing rod 33. The second long rod shell 32 is arranged at the top of the second fixing sleeve 31, and the second long rod shell 32 is connected to the first long rod shell 1 through a third fixing sleeve 35. The fixing rod 33 is arranged inside the second fixing sleeve 31, and a first mounting block 38 is arranged at the top of the fixing rod 33. A second moving pulley 39 is movably arranged in the first mounting block 38, and a first moving block 37 is movably arranged inside the second long rod shell 32. A first moving pulley 313 and a third moving pulley 310 are movably arranged in the first moving block 37. By providing a plurality of moving pulleys to change the winding path of a first steel rope 34, the transmission of force is realized and direction of force is changed, so that the operating resistance is effectively reduced.

A first connecting member 312 is arranged at the top of the first moving block 37. A first fixing block 41, a second fixing block 42 and a third fixing block 43 are arranged on one side of the handle 4.

The first steel rope 34 is arranged in the second long rod shell 32, and the head portion of the first steel rope 34 is arranged on the second fixing block 42. The first steel rope 34 penetrates through the third fixing sleeve 35 along the first long rod shell 1 and then penetrates through a square hole in the second long rod shell 32 on one side of the third fixing sleeve 35. The first steel rope 34 is sequentially wound around the first moving pulley 313, the second moving pulley 39, the third moving pulley 310 and a first clamping groove 311 in the second fixing sleeve 31. The tail portion of the first steel rope 34 is arranged inside the third fixing sleeve 35. The first steel rope 34 passes through the entire telescopic assembly 3 and is guided by the first moving pulley 313, the second moving pulley 39, the third moving pulley 310 and the first clamping groove 311 in the second fixing sleeve 31. The head portion of the first steel rope 34 is connected to the second fixing block 42 in the handle 4, and the tail portion of the first steel rope 34 is fixed inside the third fixing sleeve 35. The first moving block 37 is capable of being moved by means of the handle 4.

A second steel rope 6 is arranged on an outer wall of the first long rod shell 1, and the head portion of the second steel rope 6 is arranged on the third fixing block 43. The tail portion of the second steel rope 6 is arranged at the bottom of the first fixing sleeve 2, and the second steel rope 6 is used for limiting the handle 4, so that the handle 4 is prevented from excessively rebounding after being released.

The scissors assembly 5 comprises a second mounting shell 52 arranged at the top of the second long rod shell 32, and a first mounting shell 51 is arranged on one side of the second mounting shell 52. The second mounting shell 52 is connected to the first mounting shell 51 by means of a plurality of groups of bolts. The first mounting shell 51 and the second mounting shell 52 form a frame of the scissors assembly 5, thereby providing a mounting space and necessary structural support to the scissors blades. The first mounting shell 51 and the second mounting shell 52 are tightly connected through the plurality of groups of bolts such that the stability of the scissors assembly 5 is ensured. A first rotating shaft 57 is arranged between the first mounting shell 51 and the second mounting shell 52, and a first hexagonal shaft sleeve 515 and a second hexagonal shaft sleeve 516 are arranged on the first rotating shaft 57. A first rotating disc 54 is arranged on the first hexagonal shaft sleeve 515, and the first rotating disc 54 is located inside the first mounting shell 51. The first rotating shaft 57 penetrates through the first mounting shell 51 and the second mounting shell 52 to support the first rotating disc 54 and the second rotating disc 56. The first rotating disc 54 is arranged at one end of the first rotating shaft 57, and the first rotating disc 54 is located inside the first mounting shell 51. The position where the first rotating disc is located is the starting point for a third steel rope 53 to be wound. A second rotating disc 56 is arranged on the second hexagonal shaft sleeve 516, and a coil spring 513 is arranged in the second rotating disc 56. The second rotating disc 56 is located in the second mounting shell 52, and a second rotating shaft 518 is arranged in the second mounting shell 52. A rolling wheel 519 is movably arranged on the second rotating shaft 518, and the third steel rope 53 is wound on the first rotating disc 54. The third steel rope 53 is sequentially wound around the rolling wheel 519, the first connecting member 312 and the second rotating disc 56, and the tail portion of the third steel rope 53 is connected to the coil spring 513. When the first rotating shaft 57 rotates to pull the third steel rope 53, the coil spring 513 is compressed and stores energy, and when the external force disappears, the coil spring 513 releases energy. Thus, the second rotating disc 56 is pushed to rotate to propel the first rotating shaft 57 to rotate, so that the third steel rope 53 returns to the initial position.

The first rotating shaft 57 is provided with a first gear 58, and the first gear 58 abuts between the first hexagonal shaft sleeve 515 and the second hexagonal shaft sleeve 516. The first hexagonal shaft sleeve 515 and the second hexagonal shaft sleeve 516 connect the first rotating disc 54, the second rotating disc 56 and the first gear 58 together. When the first rotating disc 54 and the second rotating disc 56 rotate, the first gear 58 is propelled to rotate. The first gear 58 is engaged with a gear scissors blade 510. One side of the top of the second mounting shell 52 is provided with a second scissors blade 511, and the gear scissors blade 510 is movably connected to the second scissors blade 511. The first gear 58 is arranged on the first rotating shaft 57 and is located between the first hexagonal shaft sleeve 515 and the second hexagonal shaft sleeve 516. The first gear 58 is engaged with the gear scissors blade 510, and when the first gear 58 rotates, the gear scissors blade 510 is propelled to rotate, thereby achieving the closing of scissors blades such that the pruning of branches is completed.

In use, the handle 4 is held by a user to move towards the tail portion of the first long rod shell 1. At this point, the first steel rope 34 is pulled during the movement of the handle 4, and the winding path of the first steel rope 34 is changed through the first moving pulley 313, the second moving pulley 39 and the third moving pulley 310. In this way, the transmission of force is realized, the direction of force is changed and the operating resistance is reduced, thereby enabling the first moving block 37 to move towards the tail portion along the inner wall of the second long rod shell 32.

The first moving block 37 propels the first connecting member 312 to move towards the tail portion along the inner wall of the second long rod shell 32, so that the third steel rope 53 is pulled to enable the first rotating disc 54 and the second rotating disc 56 to rotate. Thus, the first rotating shaft 57 is propelled to rotate anticlockwise. At this point, the coil spring 513 in the second rotating disc 56 is compressed and stores energy, and a pinion on the first rotating shaft 57 propels the gear scissors blade 510 to rotate, thereby realizing the closing of the gear scissors blade 510 and the second scissors blade 511 such that the pruning of branches is achieved. After the completion of branch pruning, the handle 4 is released by the user, and the coil spring 513 in the second rotating disc 56 releases energy. At this point, the second rotating disc 56 is pushed to rotate, thereby propelling the first rotating shaft 57 to rotate. Thus, the third steel rope 53 returns to the initial position, and the gear scissor blade 510 is reset.

### Embodiment 2

Referring again to FIGS. 1-11, the difference between embodiment 1 and embodiment 2 is that the scissors assembly 5 comprises a first fixing cylinder 520 arranged on the second long rod shell 32, the top of the second long rod shell 32 is provided with a mounting sleeve 521, and the top of the first moving block 37 is provided with a second connecting member 522. By means of the telescopic assembly 3, the second connecting member 522 slides inside the second long rod shell 32, and the second moving block 526 is propelled to pull a pull rod 528, so that the closing of a third scissors blade 529 is achieved. In addition, a fourth fixing block 523 and a fifth fixing block 524 are arranged inside the second connecting member 522 for fixing a starting point of a fourth steel rope 525 while changing the winding direction of the fourth steel rope 525. A second moving block 526 is arranged at a position corresponding to the mounting sleeve 521 inside the second long rod shell 32, a fourth moving pulley 527 is arranged at the bottom of the second moving block 526, and the fourth moving pulley 527 is used to change the direction of the fourth steel rope 525. The top of the second moving block 526 is provided with the pull rod 528, and the second moving block 526 moves to propel the pull rod 528 to move, thereby propelling the third scissors blade 529 to rotate. One side of the pull rod 528 away from the second moving block 526 is provided with the third scissors blade 529, and a fourth scissors blade 530 is movably arranged on the third scissors blade 529 through a bolt. The third scissors blade 529 and the fourth scissors blade 530 form a cutting portion of the scissors assembly 5. The fourth scissors blade 530 is arranged on one side of the mounting sleeve 521, and the third scissors blade 529 is connected to the mounting sleeve 521 through a spring 531. When the external force disappears, the spring 531 pushes the third scissors blade 529 to return to the initial position, thereby achieving the automatic reset of the scissors assembly 5. The fourth steel rope 525 is arranged on the fourth fixing block 523, and the fourth fixing block 523 fixes a starting point of the fourth steel rope 525. The fourth steel rope 525 is sequentially wound around the fifth fixing block 524 and the fourth moving pulley 527, and the tail portion of the fourth steel rope 525 is fixed inside the first fixing cylinder 520. By arranging the fourth moving pulley 527, the winding direction of the fourth steel rope 525 is changed, and the friction and abrasion are reduced, thereby realizing the transmission of force while changing the direction of force.

During use, the user holds the handle 4 to make it move towards the tail portion of the first long rod shell 1, and the first steel rope 34 is pulled when the handle 4 is moved, thereby changing the winding path of the first steel rope 34 through the first moving pulley 313, the second moving pulley 39 and the third moving pulley 310. Thus, the transmission of force is achieved, the direction of force is changed, and the operating resistance is reduced, so that the first moving block 37 moves towards the tail portion along the inner wall of the second long rod shell 32.

The first moving block 37 propels the second connecting member 522 to move towards the tail portion along the inner wall of the second long rod shell 32, thereby pulling the fourth steel rope 525. The fourth steel rope 525 pulls the second moving block 526 to move towards the tail portion along the inner wall of the second long rod shell 32, thereby propelling the pull rod 528 to move. Thus, the closing of the third scissors blade 529 and the fourth scissors blade 530 is achieved so that the pruning of branches is realized. At this point, the spring 531 is stretched due to the closing of the third scissors blade 529. After the branch pruning is completed, the user releases the handle 4, and the spring 531 recovers to reset the third scissors blade 529.

It should be understood that the above embodiments of the present invention are merely used to illustrate or explain the principle of the present invention and do not constitute a limitation to the present invention. Therefore, any modification, equivalent replacement or improvement made without departing from the spirit and scope of the present invention shall fall within the scope of the present invention. Furthermore, the claims of the present invention are intended to cover all alterations and modifications that fall within the scope or its equivalents defined by the claims of the present invention.

What is claimed is:

1. High branch scissors, comprising:
a first long rod shell (1), wherein a first fixing sleeve (2) is arranged at a tail portion of the first long rod shell (1), wherein a handle (4) is slidably arranged on the first long rod shell (1), wherein a telescopic assembly (3) is arranged in the first long rod shell (1), and wherein a scissors assembly (5) is arranged at the top of the telescopic assembly (3).

2. The high branch scissors of claim 1, wherein the telescopic assembly (3) comprises:
a second fixing sleeve (31) arranged in the first long rod shell (1), wherein a second long rod shell (32) is arranged at the top of the second fixing sleeve (31), wherein the second long rod shell (32) is connected to the first long rod shell (1) through a third fixing sleeve (35), wherein a fixing rod (33) is arranged inside the second fixing sleeve (31), wherein a first mounting block (38) is arranged at the top of the fixing rod (33), wherein a second moving pulley (39) is movably arranged in the first mounting block (38), wherein a first moving block (37) is movably arranged inside the second long rod shell (32), wherein a first moving pulley (313) and a third moving pulley (310) are movably arranged in the first moving block (37), and wherein a first connecting member (312) is arranged at the top of the first moving block (37).

3. The high branch scissors of claim 2, wherein a first fixing block (41), a second fixing block (42) and a third fixing block (43) are arranged on one side of the handle (4).

4. The high branch scissors of claim 3, wherein the first steel rope (34) is arranged in the second long rod shell (32), wherein the head portion of the first steel rope (34) is arranged on the second fixing block (42), wherein the first steel rope (34) penetrates through the third fixing sleeve (35) along the first long rod shell (1) and then penetrates through a square hole in the second long rod shell (32) on one side of the third fixing sleeve (35), wherein the first steel rope (34) is sequentially wound around the first moving pulley (313), the second moving pulley (39), the third moving pulley (310) and a first clamping groove (311) in the second fixing sleeve (31), and wherein the tail portion of the first steel rope (34) is arranged inside the third fixing sleeve (35).

5. The high branch scissors of claim 4, wherein a second steel rope (6) is arranged on an outer wall of the first long rod shell (1), wherein the head portion of the second steel rope (6) is arranged on the third fixing block (43), and wherein the tail portion of the second steel rope (6) is arranged at the bottom of the first fixing sleeve (2).

6. The high branch scissors of claim 5, wherein the scissors assembly (5) comprises: a second mounting shell (52) arranged at the top of the second long rod shell (32), wherein a first mounting shell (51) is arranged on one side of the second mounting shell (52), wherein the second mounting shell (52) is connected to the first mounting shell (51) by means of a plurality of groups of bolts, wherein a first rotating shaft (57) is arranged between the first mounting shell (51) and the second mounting shell (52), wherein a first hexagonal shaft sleeve (515) and a second hexagonal shaft sleeve (516) are arranged on the first rotating shaft (57), wherein a first rotating disc (54) is arranged on the first hexagonal shaft sleeve (515), wherein the first rotating disc (54) is located inside the first mounting shell (51), wherein a second rotating disc (56) is arranged on the second hexagonal shaft sleeve (516), wherein a coil spring (513) is arranged in the second rotating disc (56), wherein the second rotating disc (56) is located in the second mounting shell (52), wherein a second rotating shaft (518) is arranged in the second mounting shell (52), wherein a rolling wheel (519) is movably arranged on the second rotating shaft (518), wherein a third steel rope (53) is wound on the first rotating disc (54), wherein the third steel rope (53) is sequentially wound around the rolling wheel (519), the first connecting member (312) and the second rotating disc (56), and wherein the tail portion of the third steel rope (53) is connected to the coil spring (513).

7. The high branch scissors of claim 6, wherein the first rotating shaft (57) is provided with a first gear (58), wherein the first gear (58) abuts between the first hexagonal shaft sleeve (515) and the second hexagonal shaft sleeve (516), wherein the first gear (58) is engaged with a gear scissors blade (510), wherein one side of the top of the second mounting shell (52) is provided with a second scissors blade (511), and wherein the gear scissors blade (510) is movably connected to the second scissors blade (511).

8. The high branch scissors of claim 7, wherein the scissors assembly (5) comprises:
a first fixing cylinder (520) arranged on the second long rod shell (32), wherein the top of the second long rod shell (32) is provided with a mounting sleeve (521), wherein the top of the first moving block (37) is provided with a second connecting member (522), wherein a fourth fixing block (523) and a fifth fixing block (524) are arranged inside the second connecting member (522), wherein a second moving block (526) is arranged at a position corresponding to the mounting sleeve (521) inside the second long rod shell (32), and wherein a fourth moving pulley (527) is arranged at the bottom of the second moving block (526).

9. The high branch scissors of claim 8, wherein the top of the second moving block (526) is provided with the pull rod (528), wherein one side of the pull rod (528) away from the second moving block (526) is provided with a third scissors blade (529), wherein a fourth scissors blade (530) is movably arranged on the third scissors blade (529) through a bolt, wherein the fourth scissors blade (530) is arranged on one side of the mounting sleeve (521) through a bolt, wherein the third scissors blade (529) is connected to the mounting sleeve (521) through a spring (531), wherein the fourth steel rope (525) is arranged on the fourth fixing block (523) and is sequentially wound around the fifth fixing block (524) and the fourth moving pulley (527), and wherein the tail portion of the fourth steel rope (525) is fixed inside the first fixing cylinder (520).
